(19) United States
(12) Patent Application Publication
(10) Pub. No.: US 2020/0327188 A1
(43) Pub. Date: Oct. 15, 2020

(54) PRINT SCALING FOR DIGITAL MARKUP-BASED DOCUMENTS

(71) Applicant: Microsoft Technology Licensing, LLC, Redmond, WA (US)

(72) Inventors: Sanchit GUPTA, Cupertino, CA (US); Sreejith RAMAKRISHNAN, Bengaluru (IN); Chirag Sankarnarayan VAITHEESWARAN, Bengaluru (IN); Brian Allen CARTER, San Mateo, CA (US); Robert Edward VREELAND, JR., San Jose, CA (US)

(73) Assignee: Microsoft Technology Licensing, LLC, Redmond, WA (US)

(21) Appl. No.: 16/380,675

(22) Filed: Apr. 10, 2019

(51) Int. Cl. G06F 17/21; G06F 3/12

(52) U.S. Cl. CPC G06F 17/212; G06F 3/1256; G06F 3/1208; G06F 17/218

(57) ABSTRACT

A method for print scaling includes receiving, at a computing device, a request to print a digital markup-based document as a printed document, the digital markup-based document including one or more markup tags of a markup-based language specifying formatting of the markup-based document. Target page dimensions are received for the printed document, including at least a target page height. A native-background print view of the digital markup-based document is rendered, the native-background print view having a format compatible with a print driver of the computing device. Rendered dimensions of the native-background print view are calculated. The native-background print view is resealed into a scaled-background print view having a print height that is a function of the target page height by applying a height scaling factor to the native-background print view. The scaled-background print view is output for printing.

### BACKGROUND

Most computers support printing of digital media, in which digital documents, images, or other media (e.g., rendered by a word processor, web browser, or other software application) can be output for printing.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

A method for print scaling includes receiving, at a computing device, a request to print a digital markup-based document as a printed document, the digital markup-based document including one or more markup tags of a markup-based language specifying formatting of the markup-based document. Target page dimensions are received for the printed document, including at least a target page height. A native-background print view of the digital markup-based document is rendered, the native-background print view having a format compatible with a print driver of the computing device. Rendered dimensions of the native-background print view are calculated. The native-background print view is rescaled into a scaled-background print view having a print height that is a function of the target page height by applying a height scaling factor to the native-background print view. The scaled-background print view is output for printing.

### BRIEF DESCRIPTION OF THE DRAWINGS

FIG. 1 schematically illustrates printing of an example digital markup-based document.

FIG. 2 illustrates an example method for print scaling for digital markup-based documents.

FIG. 3 schematically illustrates calculating rendered dimensions of a native-background print view of a digital markup-based document.

FIG. 4 schematically illustrates rescaling a native-background print view of a digital markup-based document to a scaled-background print view.

FIG. 5 schematically illustrates adjusting the width of a scaled-background print view to match a target page width for a printed document.

FIG. 6 illustrates print scaling for an example digital markup-based document taking the form of a table.

FIG. 7 schematically shows an example computing system.

### DETAILED DESCRIPTION

Various challenges can arise when printing digital media, often depending on the type of media that is being printed and/or the type of software application that outputs the media for printing. For instance, while word processors and portable document format (PDF) viewers often have robust printing and formatting features, web browsers tend to be primarily optimized for efficient downloading and on-screen rendering of diverse web content, without particular regard to how such content may appear when printed on paper (or another physical medium). For instance, a digital markup-based document, such as a hypertext markup language (HTML) document rendered by a web browser, is typically rendered by the web browser to optimally use available screen space of a computer display based on the size and resolution of the computer display. When printing the HTML document on paper, however, web browsers often provide limited options for scaling the document to fit on paper of a desired size and orientation. As a result, a printed document may, for instance, end up split between multiple pages in a way that cuts off content and/or otherwise inconveniences a user.

Though some web browsers may allow for globally resizing web content using a zoom feature, this is labor-intensive and can yield inconsistent results. Furthermore, some web browsers may output digital markup-based documents for processing and rendering by another software application, such as a vector-based PDF viewer, which may then apply formatting to prepare the document for printing. However, this relies on an external software application (the PDF viewer), consumes additional processing resources of the computing device, and represents increased complexity as compared to simply printing the digital markup-based document using a native printing feature of the web browser.

Accordingly, the present disclosure is directed to techniques for print scaling for digital markup-based documents. Specifically, after receiving a request to print such a document (e.g., an HTML webpage), a web browser (or other suitable software application) may rescale the document to match target page dimensions for a printed document. Such dimensions may, for instance, be specified in a print request in the form of a desired page count, paper size, and paper orientation for the printed document. Based on this information, one or both of the height and width of the digital markup-based document may be adjusted, and a scaled version of the document may be output for printing, for instance via a native print feature of the web browser.

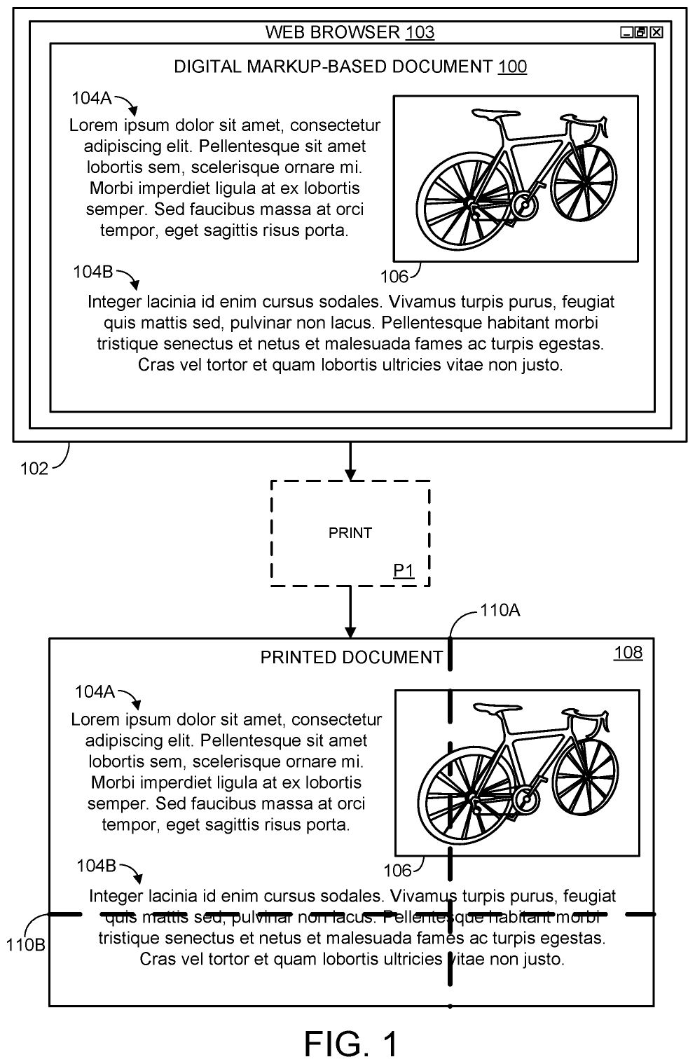

Printing of digital markup-based documents is schematically illustrated in FIG. 1. Specifically, FIG. 1 shows an example digital markup-based document 100 displayed on a computer display 102. Digital markup-based document 100 may, as one example, be an HTML webpage rendered by a web browser 103, although in other examples the digital markup-based document may be written/specified using other suitable markup-based languages, such as the standard generalized markup language (SGML), extensible markup language (XML), etc. In general, a digital markup-based document includes a set of markup tags of a markup-based language that define how visual content should be formatted or structured. For instance, HTML includes tags <h1>-<h6> for specifying headings, a <p> tag for specifying paragraphs, a <br> tag for inserting line breaks, etc. In some examples, an appearance of the visual content may be further modified by a stylesheet written in a suitable stylesheet language—e.g., Cascading Style Sheets (CSS), Document Style Semantics and Specification Language (DSSSL), Extensible Stylesheet Language (XSL), and similar.

Furthermore, digital markup-based documents may be rendered and displayed by any suitable software application. The present disclosure primarily focuses on a scenario in which the digital markup-based documents being printed are webpages rendered by a web browser, although this is not limiting. As an alternative example, the software application used to display the digital markup-based document may be an editing or publishing program used to design and create markup-based documents—e.g., for eventual publishing on the Internet.

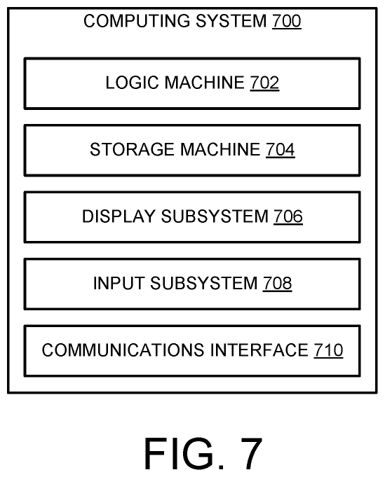

Furthermore, the print scaling techniques described herein may be performed by any suitable computing device having any suitable hardware configuration and form factor. For instance, in FIG. 1, digital markup-based document 100 is displayed on a computer display 102. Such a computer display may be integrated with or external to the computing device that rescales and outputs the digital markup-based document for printing. As non-limiting examples, the computing device may take the form of a desktop computer, laptop computer, mobile device (e.g., smartphone, tablet), augmented/virtual reality device, wearable device, media center, smart printer, etc. Furthermore, the digital markup-based document may be output for printing by any suitable printer, and such a printer may be integrated with or external to the computing device. In some examples, the computing device may be implemented as computing system 700 described below with respect to FIG. 7.

As shown, digital markup-based document 100 includes two text boxes 104A and 104B, as well as an image 106. These are non-limiting examples of content that may be included in a digital markup-based document. In general, digital markup-based documents may include any content supported by their markup language (e.g., HTML) and/or any additional formatting/styling languages applied to the document—e.g., cascading style sheets (CSS). Such content may include text, images, videos, tables, charts, user interface elements (e.g., text entry fields, buttons, toggles, playback controls), etc. Such content may have any arbitrary layout supported by the markup and/or stylesheet languages.

In FIG. 1, the computing device receives a request P1 to print the digital markup-based document as a printed document. Such a request may take any suitable form and be received in any suitable way. For instance, as discussed above, in some examples the digital markup-based document may take the form of an HTML document rendered by a web browser. In such examples the request to print the HTML document may be received by the web browser, and a version of the document may ultimately be output for printing via a native browser printing feature of the web browser. The request may be provided manually by a user—e.g., by selecting a “print” option from a menu or inputting a corresponding shortcut keystroke. Alternatively, however, the print request may be automatically generated, for instance via another software application running on the computing device or an automated script running as part of the digital markup-based document.

Furthermore, the print request may specify any suitable information regarding the desired appearance of the printed document. In general, the print request may include target page dimensions for the printed document, including at least a target page height. This may be specified in any suitable way. For instance, the print request may specify a desired paper size (e.g., 8.5×11 in letter paper), paper orientation (e.g., portrait or landscape), and/or page count for the printed document. Based on this information, the target dimensions of the printed document may be calculated—e.g., in millimeters, inches, or another suitable unit. The print request may explicitly indicate target dimensions for the printed document or may indicate that one or more system defaults should be used.

In some examples, the target dimensions for the printed document may be converted by the computing device to use different units—e.g., the print dimensions measured in millimeters may be converted such that the dimensions are measured in pixels along the height and width dimensions. This may facilitate later comparisons to rendered dimensions of a background print view expressed in pixels, as will be described below.

FIG. 1 also shows a printed document 108 corresponding to digital markup-based document 100. However, in FIG. 1, no scaling or resizing has been applied to the digital markup-based document prior to printing. As such, the printed document exceeds both a target height 110A as well as a target width 110B, indicated by dark dashed lines. These target dimensions may, for instance, correspond to a desired paper size and orientation for the printed document, meaning the printed document shown in FIG. 1 is split between four different pages, which will typically be undesirable as text box 104B and image 106 are cut off.

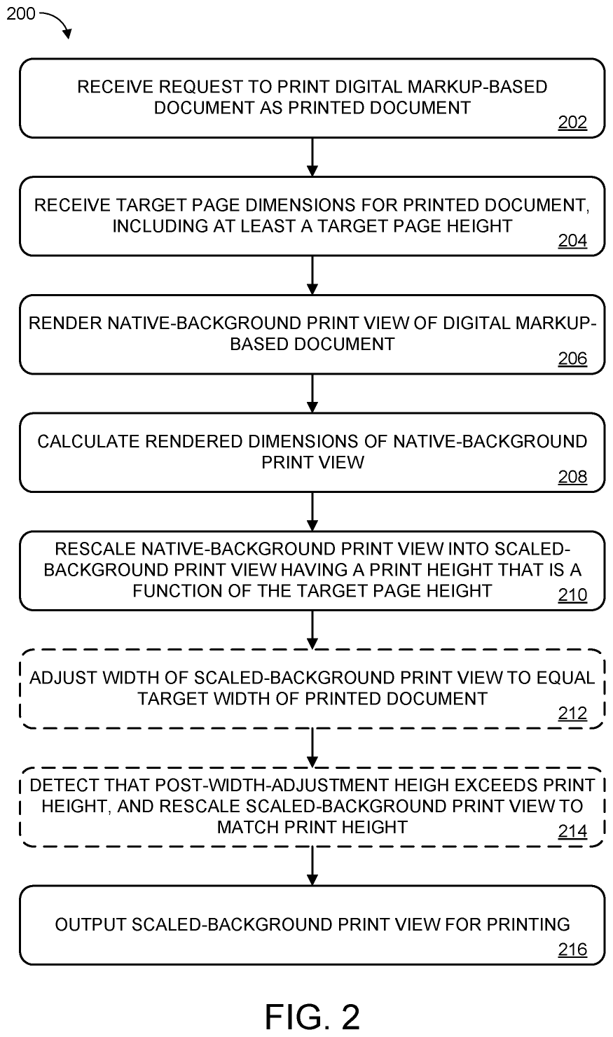

Accordingly, FIG. 2 illustrates an example method 200 for page scaling for digital markup-based documents. Method 200 may be implemented on any suitable computing device having any suitable form factor and hardware configuration, as discussed above. In some examples, method 200 may be implemented on computing system 700 described below with respect to FIG. 7.

At 202, method 200 includes receiving a request to print a digital markup-based document as a printed document. At 204, method 200 includes receiving target page dimensions for the printed document, including at least a target page height. Such steps may be performed substantially as discussed above with respect to FIG. 1. Notably, the request to print the digital markup-based document may take any suitable form and be received in any suitable way, and the target dimensions for the printed document may be specified in any suitable manner.

At 206, method 200 includes rendering a native-background print view of the digital markup-based document. For instance, HTML supports a separate set of styles that can be applied to a document prior to printing. As one nonlimiting example, the <style> tag in HTML can be used to apply styling (e.g., via CSS) to visual content, and different styles can be applied for different media (e.g., on-screen vs printing) using the MEDIA attribute of the <style> tag. In this manner, a document can have one appearance when presented on-screen, and a different appearance when rendered for printing. In general, a background print view may correspond to any rendering surface that is compatible with a print driver of the computing device that receives the print request. In some examples, the background print view may be “reflowable,” in that one or more aspects of the presentation of the background print view can be modified based on aspects of an output device (e.g., display size, resolution, print dimensions).

Furthermore, the web browser or other application may apply styling in such a way that the background print view is invisible to a user. In some examples, however, the web browser or other application may display the background print view to a user, for instance as a print preview. The term “native-background print view” refers to a background print view that still has the same size as the regular view of the digital markup-based document that is displayed. In other words, the background print view has not yet been rescaled—e.g., to match target page dimensions.

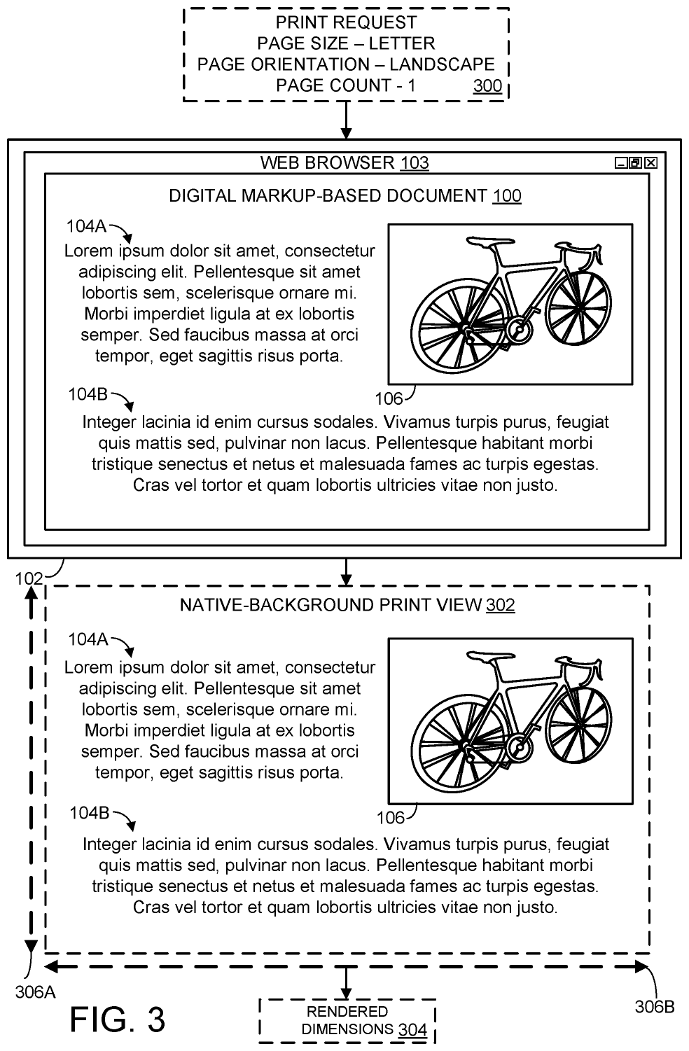

This is schematically illustrated in FIG. 3, which again shows digital markup-based document 100 from FIG. 1. The computing device receives a print request 300 specifying a page size (letter), page orientation (landscape), and page count (one) for the printed document. Next, the computing device renders a native-background print view 302 of the digital markup-based document. Native-background print view 302 is shown with a dashed outline to indicate that it is not displayed on the computer display.

Returning briefly to FIG. 2, at 208, method 200 includes calculating rendered dimensions of the native-background print view. In general, this includes determining a physical size of the native-background print view based on how the digital markup-based document is displayed by the computing device. For instance, the rendered dimensions of the native background-print view may be calculated based on a size of the native background-print view in pixels and a display resolution of the computer display with which the digital markup-based document is presented. For instance, a 24″ computer display having a 1920×1080 pixel resolution will have a pixel density of approximately 91.79 pixels per inch. Thus, a native-background print view having a height of 1377 px may have a rendered height of approximately 15″. It will be understood, however, that the rendered dimensions of the native background-print view may be calculated in any suitable way. For instance, as discussed above, in some examples the rendered dimensions of the background print view may be measured in pixels, and compared to target print dimensions for the printed document also measured in pixels.

This is also schematically illustrated in FIG. 3, in which the rendered dimensions 304 of the native-background print view 302 are calculated. In FIG. 3, this is represented by dashed arrows 306A and 306B shown below and to the side of the native-background print view, which indicate that the rendered height and width of the native-background print view are calculated. In other examples, however, other suitable dimensions may be calculated in addition to or instead of the height and width. For instance, the computing device may only calculate one of the height and the width, without calculating the other.

Returning to FIG. 2, at 210, method 200 includes resealing the native-background print view into a scaled-background print view having a print height that is a function of the target page height for the printed document. This may be done by applying a height scaling factor to the native-background print view, which may in turn be calculated based on the ratio between the rendered height of the native-background print view and the print height. In a simplified example, if the rendered height of the native-background print view is exactly twice as tall as the print height (e.g., a print height of 500 px and a rendered height of 1000 px), then the height scaling factor would be equal to 0.5.

The height scaling factor may be applied to the native background-print view in any suitable way. In general, it may be undesirable to rescale content in the digital markup-based document along one dimension (e.g., height) independent from the other dimension (e.g., width), as this will affect the aspect ratio of the content, potentially resulting in a distorted “stretched” or “squished” appearance. Thus, in one example, the height scaling factor may only be applied to text in the native-background print view. For instance, text in the native-background print view may use a fixed root font size (e.g., via the em or rem units in CSS), and the height scaling factor may be applied to the fixed root font size to change the size of the text, thereby rescaling the native-background print view. In cases where the native-background print view does not already use a fixed root font size (e.g., a fixed view width is used instead), text in the native-background print view may be changed to use a fixed root font size prior to rescaling. However, in other examples, content other than text may be rescaled along one or both dimensions, even if such rescaling affects the aspect ratio of such content. For example, images (and/or other suitable content) in the native-background print view may be scaled by height and/or width. In cases where such content is scaled by both height and width, the scaling may optionally be done in a manner that preserves the original aspect ratio of the content—e.g., so images do not have a distorted appearance.

Furthermore, the manner in which the height scaling factor is applied can depend on the specific software application (e.g., web browser) that receives the print request. For instance, in the Google Chrome® browser, applying the height scaling factor may involve calling a “transform: scale” function built-in to the browser. For other web browsers, such as the Mozilla Firefox® browser, and/or the Internet Explorer® and Edge® browsers from Microsoft, applying the height scaling factor may involve scaling down the root font size as discussed above.

Furthermore, as indicated above, the native-background print view is rescaled to have a print height that is a function of the target page height of the printed document. This may in turn depend on the target page count of the printed document. For instance, when the printed document has a target page count of one page, then the print height may be equal to the target page height, as the scaled-background print view will then have substantially the same height as the paper on which it will be printed, depending on the page orientation. Alternatively, the print height may be less than the target page height—e.g., to account for document margins.

However, when the page count is more than one (or between zero and one for fractional page counts) the print height may have another suitable relationship with the target page height. In one example, when the printed document has a target page count of n pages, then the print height of the scaled-background print view may be equal to the target page height multiplied by n. Again, however, in alternative examples the print height may be less than the target page height multiplied by n—e.g., to account for a document margin on each page.

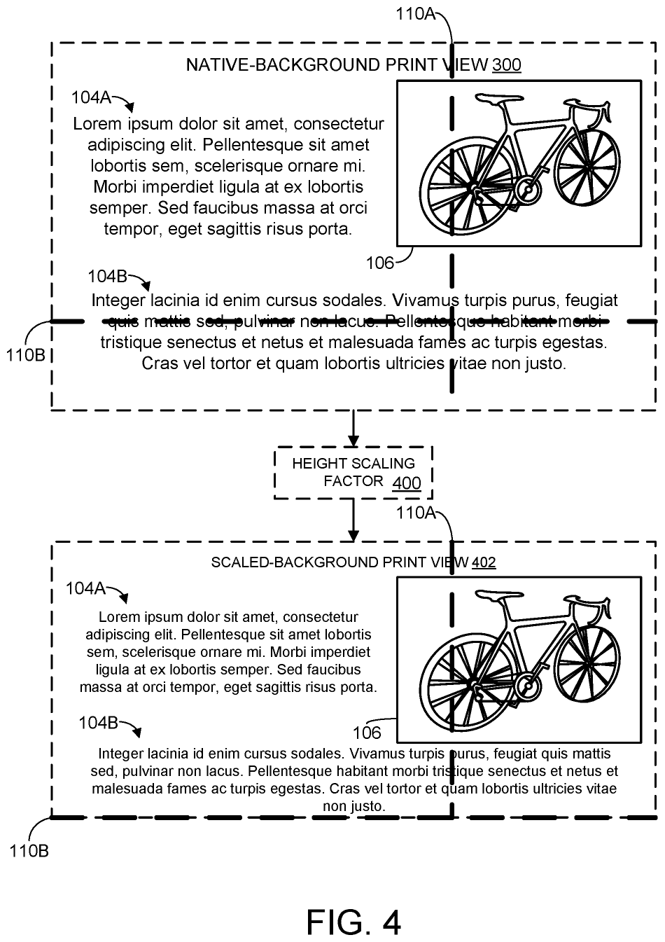

Rescaling of a native-background print view is schematically illustrated in FIG. 4. Specifically, FIG. 4 again shows native-background print view 300 of FIG. 3, along with text boxes 104A/B and image 106, and target dimensions 110A/B. In FIG. 4, a height scaling factor 400 is applied to the native-background print view to produce a scaled-background print view 402. Notably, the height of the scaled-background print view is approximately equal to the target height of the printed document, as all content in the scaled-background print view fits above dashed line 110B. Furthermore, this reduction in height is achieved by reducing the size of text in text boxes 104A and 104B. In this example, the dimensions of image 106 have not changed. This is not limiting, however, and in other examples images (and other suitable content in the digital markup-based document) may be resealed along one or both dimensions along with any text in the document.

In the illustrated example, though the scaled-background print view is now equal to the target height of the printed document, it still exceeds a target width of the printed document. In other words, if printed as-is, the scaled-background print view would still exceed the target page count of one, as at least some content would be cut off and run over onto a second page. Thus, rescaling the native-background print view may further include, after applying the height scaling factor, adjusting a width of the scaled-background print view such that a width of the scaled-background print view is equal to the target width of the printed document. As such, returning briefly to FIG. 2, at 212, method 200 optionally includes adjusting the width of the scaled-background print view to equal the target width of the printed document.

In some scenarios, this may be done substantially as described above with respect to height scaling. For instance, a target page width for the printed document may be compared to a rendered width of the background print view to calculate a width scaling factor, which may then be applied to the background print view to produce a scaled-background print view.

In other scenarios, however, adjusting the width of the scaled-background print view need not include rescaling or resizing content in the scaled-background print view. Rather, many markup-based languages (including HTML) support dynamic width adjustment of rendered documents, for instance to accommodate computer displays (or user interface windows) having variable dimensions. As such, the width of the scaled-background print view may be adjusted by changing a layout of content in the scaled-background print view. This can include, for example, changing text wrapping in the scaled-background print view. Additionally, or alternatively, the positions of content (e.g., images, text boxes, user interface elements) in the scaled-background print view may be adjusted to accommodate a target width for the printed document.

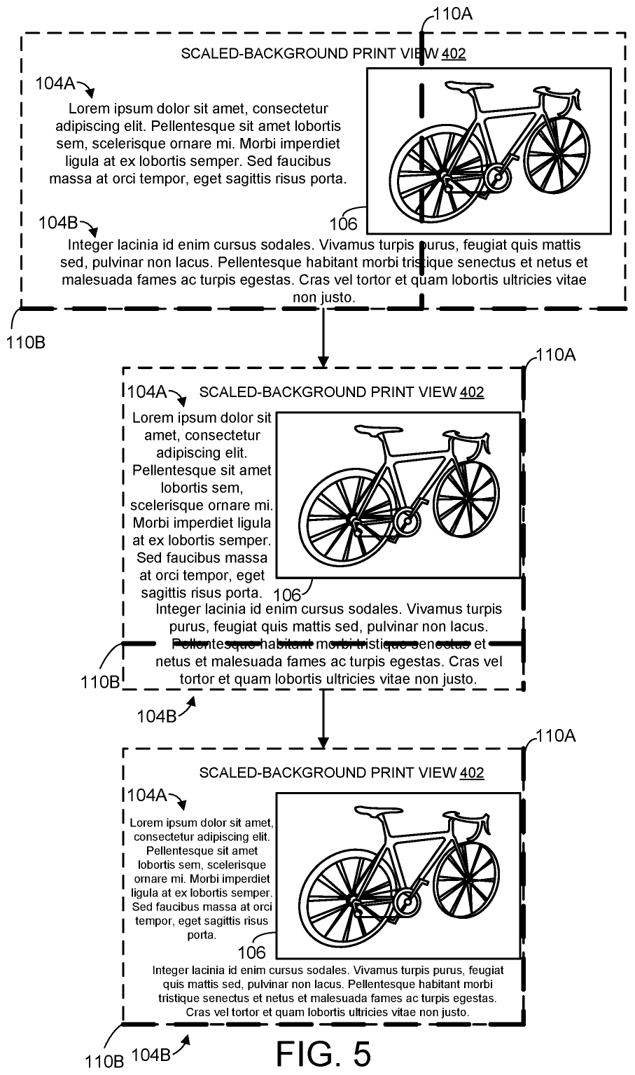

Width adjustment of a scaled-background print view is schematically illustrated in FIG. 5. FIG. 5 again shows scaled-background print view 402 of FIG. 4, after the height scaling factor has been applied. FIG. 5 also depicts width adjustment of the scaled-background print view, in which text wrapping in the scaled-background print view has been changed such that the width of the scaled-background print view equals the target width of the printed document, as indicated by dashed line 110A.

However, in the illustrated example, adjusting the width of the scaled-background print view has also affected the height of the scaled-background print view, such that the height once again exceeds the print height. As such, returning briefly to FIG. 2, at 214 method 200 optionally includes, after adjusting the width of the scaled-background print view, detecting that a post-width-adjustment height of the scaled-background print view has changed to exceed the print height, and applying a second height scaling factor to the scaled-background print view to match the print height. This may be done substantially as discussed above with respect to initial rescaling of the native-background print view. In other words, the second height scaling factor may be calculated based on a ratio between the post-width-adjustment height of the scaled-background print view and the print height. The second height scaling factor may then be applied to the scaled-background print view, for instance to a fixed root font size, to modify the height of the scaled-background print view. This is also shown in FIG. 5, in which the height of scaled-background print view 402 is again reduced by decreasing the font size, to the point where the dimensions of the scaled-background print view match both the target height and target width. Furthermore, this process can be iterated any number of times until the scaled-background print view has dimensions equaling the target dimension for the printed document. In other words, the scaled-background print view may undergo any number of height and/or width adjustments.

The present disclosure has primarily discussed print scaling with respect to first rescaling the height of a digital markup-based document, then adjusting the width of the document—e.g., by changing a layout of the document via text wrapping and/or other changes. However, in some scenarios, content in the digital markup-based document may be resized or resealed to equal the target width of the printed document in addition to or instead of resizing/rescaling content to equal the target height. Furthermore, the height and width rescaling may be performed in any order—in other words, the size of text and/or other content in the digital markup-based document may be changed to equal the target width either before or after the target height is met. In one example, in cases where both the height and width of the native-background print view exceed target dimensions for the printed document, scaling factors for both height and width may be calculated at the same time. At this point, whichever scaling factor is smaller may be applied to the native-background print view to produce a scaled-background print view.

Returning briefly to FIG. 2, at 216, method 200 includes outputting the scaled-background print view for printing. As discussed above, the scaled-background print view may be output to any suitable printer, which may be integrated with or external to the computing device. Furthermore, though the present disclosure has primarily discussed printing of the digital markup-based document on paper, it will be understood that any suitable physical medium may be used, including paper, cardstock, cardboard, wood metal or plastic (e.g., in the case of an etching printer), etc. Furthermore, the scaled-background print view need not be output for immediate printing. Rather, the scaled-background print view may be saved by the computing device (e.g., as an image or a separate document) for later printing when necessary or convenient.

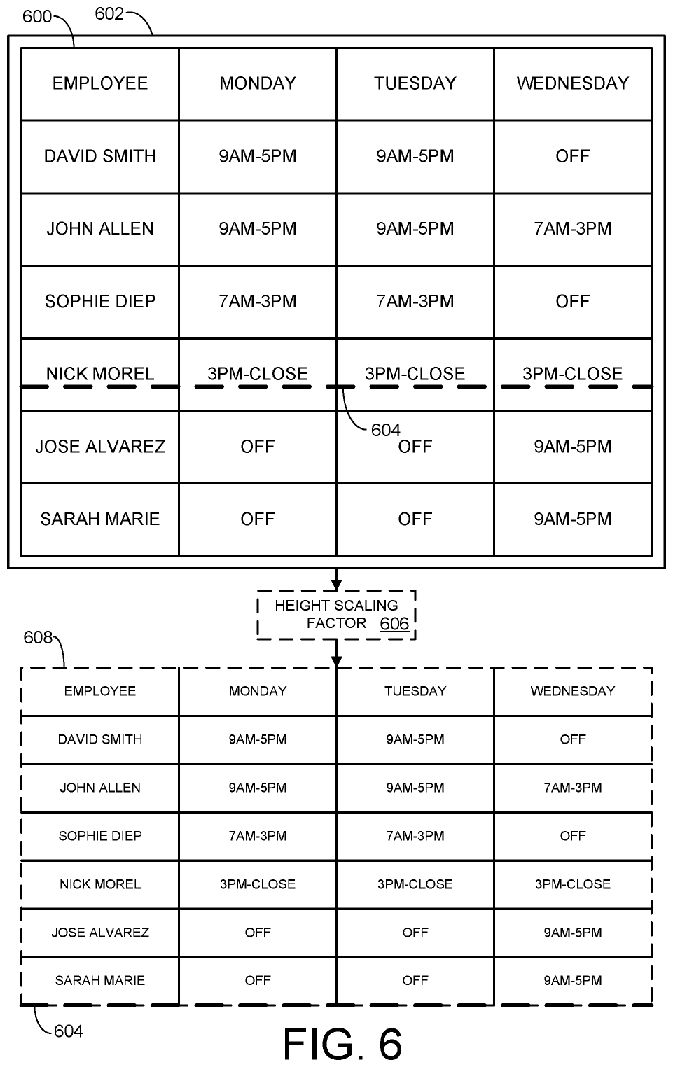

The print scaling techniques described above may be particularly advantageous with regard to printing calendars, schedules, and other tables. For instance, FIG. 6 depicts another example digital markup-based document 600 presented on a computer display 602. In this example, however, the digital markup-based document is a table listing shift schedules for a list of employees. Based on receiving a request to print the digital markup-based document, the computing device has calculated a target height for a printed version of the digital markup-based document indicated by dashed line 604.

Next, as discussed above, the computing device applies a height scaling factor 606 to a native-background print view of the digital markup-based document (not shown) to generate a scaled-background print view 608 of the digital markup-based document that equals the print height, as indicated by dashed line 604. To this end, the font size in the scaled-background print view is reduced as compared to the original digital markup-based document, causing a corresponding decrease in the height of each cell in the table. Thus, the employee schedule can be printed on one page, while previously it would have required two pages. In this example, the width of the digital markup-based document already matched the target width for the printed document, and thus no width adjustments were performed.

Furthermore, in this example, the size of the digital markup-based document was reduced to fit on a single page. In other examples, however, such documents may be scaled to fit on multiple pages, and this can involve either decreasing or increasing the height (and/or width) of the digital markup-based document to match target dimensions that, when printed, will fit on the desired number of pages. In scenarios where a single digital markup-based document is split between multiple pages, there will inherently be breaks between each page, which can cause content in the document to be cut off. Thus, in such scenarios, the computing device may be configured to specify page breaks when outputting the scaled-background print view for printing. Such page breaks may be placed at positions within the document that avoid cutting off content—for instance, at a natural line between table cells. In some scenarios, this may be done to logically separate the digital markup-based document into pages with distinct categories of content. As one example, in an employee schedule such as is shown in FIG. 6, line breaks may be placed such that employees belonging to one category (e.g., servers) may all be listed on one page, while employees belonging to a different category (e.g., cooks) may be listed on a different page.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 7 schematically shows a non-limiting embodiment of a computing system 700 that can enact one or more of the methods and processes described above. Computing system 700 is shown in simplified form. Computing system 700 may take the form of one or more personal computers, server computers, tablet computers, home-entertainment computers, network computing devices, gaming devices, mobile computing devices, mobile communication devices (e.g., smart phone), and/or other computing devices.

Computing system 700 includes a logic machine 702 and a storage machine 704. Computing system 700 may optionally include a display subsystem 706, input subsystem 708, communication subsystem 710, and/or other components not shown in FIG. 7.

Logic machine 702 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 704 includes one or more physical devices configured to hold instructions executable by the logic machine to implement the methods and processes described herein. When such methods and processes are implemented, the state of storage machine 704 may be transformed—e.g., to hold different data.

Storage machine 704 may include removable and/or built-in devices. Storage machine 704 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 704 may include volatile, nonvolatile, dynamic, static, read/write, read-only, random-access, sequential-access, location-addressable, file-addressable, and/or content-addressable devices.

It will be appreciated that storage machine 704 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 702 and storage machine 704 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 700 implemented to perform a particular function. In some cases, a module, program, or engine may be instantiated via logic machine 702 executing instructions held by storage machine 704. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 706 may be used to present a visual representation of data held by storage machine 704. This visual representation may take the form of a graphical user interface (GUI). As the herein described methods and processes change the data held by the storage machine, and thus transform the state of the storage machine, the state of display subsystem 706 may likewise be transformed to visually represent changes in the underlying data. Display subsystem 706 may include one or more display devices utilizing virtually any type of technology. Such display devices may be combined with logic machine 702 and/or storage machine 704 in a shared enclosure, or such display devices may be peripheral display devices.

When included, input subsystem 708 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 710 may be configured to communicatively couple computing system 700 with one or more other computing devices. Communication subsystem 710 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 700 to send and/or receive messages to and/or from other devices via a network such as the Internet.

In an example, a method for print scaling comprises: receiving, at a computing device, a request to print a digital markup-based document as a printed document, the digital markup-based document including one or more markup tags of a markup-based language specifying formatting of the digital markup-based document; receiving target page dimensions for the printed document, including at least a target page height; rendering a native-background print view of the digital markup-based document, the native-background print view having a format compatible with a print driver of the computing device; calculating rendered dimensions of the native-background print view; rescaling the native-background print view into a scaled-background print view having a print height that is a function of the target page height by applying a height scaling factor to the native-background print view; and outputting the scaled-background print view for printing. In this example or any other example, the printed document has a target page count of n pages, and the print height of the scaled-background print view is equal to the target page height multiplied by n. In this example or any other example, rescaling the native-background print view further comprises, after applying the height scaling factor, adjusting a width of the scaled-background print view such that a width of the scaled-background print view is equal to a target width of the printed document. In this example or any other example, rescaling the native-background print view further comprises, after adjusting the width of the scaled-background print view, detecting that a post-width-adjustment height of the scaled-background print view has changed to exceed the print height, and applying a second height scaling factor to the scaled-background print view to match the print height. In this example or any other example, the width of the scaled-background print view is adjusted by changing a layout of content in the scaled-background print view. In this example or any other example, changing the layout of content in the scaled-background print view includes changing text wrapping in the scaled-background print view. In this example or any other example, the digital markup-based document is a hypertext markup language (HTML) document. In this example or any other example, the HTML document is rendered for display by a web browser, the request to print the HTML document is received by the web browser, and the scaled-background print view is output for printing to a print driver via a native browser printing feature of the web browser. In this example or any other example, the rendered dimensions of the native-background print view are calculated based on a size of the native-background print view in pixels and a display resolution of a display with which the digital markup-based document is presented. In this example or any other example, the method further comprises, prior to rescaling the native-background print view, changing text in the native-background print view to use a fixed root font size, and the height scaling factor is applied to the fixed root font size to rescale the native-background print view. In this example or any other example, the digital markup-based document has a fixed root font size, and the height scaling factor is applied to the fixed root font size to rescale the native-background print view. In this example or any other example, receiving target page dimensions for the printed document includes receiving a paper size and a paper orientation for the printed document.

In an example, a computing device comprises: a logic machine; and a storage machine holding instructions executable by the logic machine to: receive a request to print a digital markup-based document as a printed document, the digital markup-based document including one or more markup tags of a markup-based language specifying formatting of the digital markup-based document; receive target page dimensions for the printed document, including at least a target page height; render a native-background print view of the digital markup-based document, the native-background print view having a format compatible with a print driver of the computing device; calculate rendered dimensions of the native-background print view; rescale the native-background print view into a scaled-background print view having a print height that is a function of the target page height by applying a height scaling factor to the native-background print view; and output the scaled-background print view for printing. In this example or any other example, the printed document has a target page count of n pages, and the print height of the scaled-background print view is equal to the target page height multiplied by n. In this example or any other example, rescaling the native-background print view further comprises, after applying the height scaling factor, adjusting a width of the scaled-background print view such that a width of the scaled-background print view is equal to a target width of the printed document. In this example or any other example, rescaling the native-background print view further comprises, after adjusting the width of the scaled-background print view, detecting that a post-width-adjustment height of the scaled-background print view has changed to exceed the print height, and applying a second height scaling factor to the scaled-background print view to match the print height. In this example or any other example, the digital markup-based document is a hypertext markup language (HTML) document. In this example or any other example, the instructions are further executable to, prior to rescaling the native-background print view, change text in the native-background print view to use a fixed root font size, and the height scaling factor is applied to the fixed root font size to rescale the native-background print view. In this example or any other example, receiving target page dimensions for the printed document includes receiving a paper size and a paper orientation for the printed document.

In an example, a storage machine holds instructions executable by a logic machine of a computing device to: receive a request to print a digital markup-based document as a printed document, the digital markup-based document including one or more markup tags of a markup-based language specifying formatting of the digital markup-based document; receive target page dimensions for the printed document, including at least a target page height; render a native-background print view of the digital markup-based document, the native-background print view having a format compatible with a print driver of the computing device; calculate rendered dimensions of the native-background print view; rescale the native-background print view into a scaled-background print view having a print height that is a function of the target page height by applying a height scaling factor to the native-background print view; and output the scaled-background print view for printing.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method for print scaling, comprising:
receiving, at a computing device, a request to print a digital markup-based document as a printed document, the digital markup-based document including one or more markup tags of a markup-based language specifying formatting of the digital markup-based document;
receiving target page dimensions for the printed document, including at least a target page height;
rendering a native-background print view of the digital markup-based document, the native-background print view having a format compatible with a print driver of the computing device;
calculating rendered dimensions of the native-background print view;
resealing the native-background print view into a scaled-background print view having a print height that is a function of the target page height by applying a height scaling factor to the native-background print view; and
outputting the scaled-background print view for printing.

2. The method of claim 1, where the printed document has a target page count of n pages, and the print height of the scaled-background print view is equal to the target page height multiplied by n.

3. The method of claim 1, where rescaling the native-background print view further comprises, after applying the height scaling factor, adjusting a width of the scaled-background print view such that a width of the scaled-background print view is equal to a target width of the printed document.

4. The method of claim 3, where rescaling the native-background print view further comprises, after adjusting the width of the scaled-background print view, detecting that a post-width-adjustment height of the scaled-background print view has changed to exceed the print height, and applying a second height scaling factor to the scaled-background print view to match the print height.

5. The method of claim 3, where the width of the scaled-background print view is adjusted by changing a layout of content in the scaled-background print view.

6. The method of claim 5, where changing the layout of content in the scaled-background print view includes changing text wrapping in the scaled-background print view.

7. The method of claim 1, where the digital markup-based document is a hypertext markup language (HTML) document.

8. The method of claim 7, where the HTML document is rendered for display by a web browser, the request to print the HTML document is received by the web browser, and the scaled-background print view is output for printing to a print driver via a native browser printing feature of the web browser.

9. The method of claim 1, where the rendered dimensions of the native-background print view are calculated based on a size of the native-background print view in pixels and a display resolution of a display with which the digital markup-based document is presented.

10. The method of claim 1, further comprising, prior to rescaling the native-background print view, changing text in the native-background print view to use a fixed root font size, and where the height scaling factor is applied to the fixed root font size to rescale the native-background print view.

11. The method of claim 1, where the digital markup-based document has a fixed root font size, and where the height scaling factor is applied to the fixed root font size to rescale the native-background print view.

12. The method of claim 1, where receiving target page dimensions for the printed document includes receiving a paper size and a paper orientation for the printed document.

13. A computing device, comprising:
a logic machine; and
a storage machine holding instructions executable by the logic machine to:
receive a request to print a digital markup-based document as a printed document, the digital markup-based document including one or more markup tags of a markup-based language specifying formatting of the markup-based document;
receive target page dimensions for the printed document, including at least a target page height;
render a native-background print view of the digital markup-based document, the native-background print view having a format compatible with a print driver of the computing device;
calculate rendered dimensions of the native-background print view;
rescale the native-background print view into a scaled-background print view having a print height that is a function of the target page height by applying a height scaling factor to the native-background print view; and
output the scaled-background print view for printing.

14. The computing device of claim 13, where the printed document has a target page count of n pages, and the print height of the scaled-background print view is equal to the target page height multiplied by n.

15. The computing device of claim 13, where rescaling the native-background print view further comprises, after applying the height scaling factor, adjusting a width of the scaled-background print view such that a width of the scaled-background print view is equal to a target width of the printed document.

16. The computing device of claim 15, where rescaling the native-background print view further comprises, after adjusting the width of the scaled-background print view, detecting that a post-width-adjustment height of the scaled-background print view has changed to exceed the print height, and applying a second height scaling factor to the scaled-background print view to match the print height.

17. The computing device of claim 13, where the digital markup-based document is a hypertext markup language (HTML) document.

18. The computing device of claim 13, where the instructions are further executable to, prior to rescaling the native-background print view, change text in the native-background print view to use a fixed root font size, and where the height scaling factor is applied to the fixed root font size to rescale the native-background print view.

19. The computing device of claim 13, where receiving target page dimensions for the printed document includes receiving a paper size and a paper orientation for the printed document.

20. A storage machine holding instructions executable by a logic machine of a computing device to:
receive a request to print a digital markup-based document as a printed document, the digital markup-based document including one or more markup tags of a markup-based language specifying formatting of the digital markup-based document;
receive target page dimensions for the printed document, including at least a target page height;
render a native-background print view of the digital markup-based document, the native-background print view having a format compatible with a print driver of the computing device;
calculate rendered dimensions of the native-background print view;
rescale the native-background print view into a scaled-background print view having a print height that is a function of the target page height by applying a height scaling factor to the native-background print view; and
output the scaled-background print view for printing.
